(19) United States
(12) Patent Application Publication
(10) Pub. No.: US 2019/0236126 A1
(43) Pub. Date: Aug. 1, 2019

(54) SYSTEM AND METHOD FOR AUTOMATIC CREATION OF REGULATORY REPORTS

(71) Applicant: Vatbox, Ltd., Herzeliya (IL)

(72) Inventors: Noam GUZMAN, Ramat Hasharon (IL); Isaac SAFT, Kfar Neter (IL)

(73) Assignee: Vatbox, Ltd., Herzeliya (IL)

(21) Appl. No.: 16/376,854

(22) Filed: Apr. 5, 2019

Related U.S. Application Data
(63) Continuation of application No. PCT/US2017/064191, filed on Dec. 1, 2017.
Application No. PCT/US2017/064191 is a continuation-in-part of application No. 15/361,934, filed on Nov. 28, 2016.
Application No. 15/361,934 is a continuation-in-part of application No. 15/361,934, filed on Nov. 28, 2016.
(60) Provisional application No. 62/428,568, filed on Dec. 1, 2016.
(60) Provisional application No. 62/260,553, filed on Nov. 29, 2015.
(60) Provisional application No. 62/261,355, filed on Dec. 1, 2015.

(51) Int. Cl. G06F 17/24; G06Q 10/06

(52) U.S. Cl. CPC G06F 17/248; G06Q 10/067; G06F 17/243

(57) ABSTRACT

A system and method for creating regulatory reports based on enterprise data, including: determining if regulatory reporting requirements are satisfied based on enterprise data, wherein the enterprise data is from an enterprise server; retrieving a reporting form electronic document when the reporting requirements have not been satisfied, wherein the reporting form electronic document includes at least partially unstructured data; analyzing the reporting form electronic document to determine at least one reporting requirement parameter relevant to the regulatory reporting requirements; creating a template based on the analysis of the reporting form electronic document, wherein the template is a structured dataset including the determined at least one reporting requirement parameter; and creating a report electronic document based on the template and the enterprise data, wherein the report electronic document is the reporting form electronic document completed using at least a portion of the enterprise data in compliance with the regulatory reporting requirements.

### CROSS-REFERENCE TO RELATED APPLICATIONS

This application is a continuation of International Application PCT/US2017/064191 filed on Dec. 1, 2017, which claims the benefit of U.S. Provisional Application No. 62/428,568 filed on Dec. 1, 2016. International Application PCT/US2017/064191 is a continuation-in-part of U.S. patent application Ser. No. 15/361,934 filed on Nov. 28, 2016, now pending. This application is also a continuation-in-part of the above-referenced U.S. patent application Ser. No. 15/361,934. The above-referenced U.S. patent application Ser. No. 15/361,934 claims the benefit of U.S. Provisional Application No. 62/260,553 filed on Nov. 29, 2015, and of U.S. Provisional Application No. 62/261,355 filed on Dec. 1, 2015. The contents of the above-referenced applications are hereby incorporated by reference.

### TECHNICAL FIELD

The present disclosure relates generally to regulatory reports, and more particularly to the creation and submission of regulatory reports based on enterprise data.

### BACKGROUND

Taxes and other levies are imposed upon a taxpayer, whether they be an individual or a legal entity, by a state or subdivision thereof in order to fund various public expenditures. Taxes are also imposed by many administrative divisions for various activities. A failure to pay, evasion of, or resistance to taxation is usually punishable by law.

In cases of legal entities such as corporations or enterprises, the tax reporting requirements can be quite involved, especially in cases where the enterprise is a multi-national company and various locations related to the company, such as locations of stores or offices, can levy separate taxes. As an enterprise grows in size and revenue, so too do the reporting requirements grow in order to meet the regulations.

As laws and regulations tend to differ from one country or state to another, the tracking and reporting requirements for tax compliance can become complicated and often require knowledge and diligence for full conformity. A failure to meet the regulation will often result in fines and may cause the relevant tax authorities to commence formal inspections or audits, which enterprises generally prefer to avoid due to the high cost of money and time involved.

As a result, enterprises may hire professional human resource and taxation firms in order to manage the required reporting. However, disparities between recordkeeping documents can cause significant problems for businesses such as, for example, failure to properly report earnings to tax authorities. Additionally, submitting required reports in a timely manner can become an unwieldy task, especially when balancing the regulations of multiple jurisdictions.

It would therefore be advantageous to provide a solution that would overcome the deficiencies of the prior art.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for creating regulatory reports based on enterprise data, including: determining if regulatory reporting requirements are satisfied based on enterprise data, wherein the enterprise data is from an enterprise server; retrieving a reporting form electronic document when the reporting requirements have not been satisfied, wherein the reporting form electronic document includes at least partially unstructured data; analyzing the reporting form electronic document to determine at least one reporting requirement parameter relevant to the regulatory reporting requirements; creating a template based on the analysis of the reporting form electronic document, wherein the template is a structured dataset including the determined at least one reporting requirement parameter; and creating a report electronic document based on the template and the enterprise data, wherein the report electronic document is the reporting form electronic document completed using at least a portion of the enterprise data in compliance with the regulatory reporting requirements.

Certain embodiments disclosed herein also include a non-transitory computer readable medium having stored thereon instructions for causing a processing circuitry to perform a process, the process comprising: determining if regulatory reporting requirements are satisfied based on enterprise data, wherein the enterprise data is from an enterprise server; retrieving a reporting form electronic document when the reporting requirements have not been satisfied, wherein the reporting form electronic document includes at least partially unstructured data; analyzing the reporting form electronic document to determine at least one reporting requirement parameter relevant to the regulatory reporting requirements; creating a template based on the analysis of the reporting form electronic document, wherein the template is a structured dataset including the determined at least one reporting requirement parameter; and creating a report electronic document based on the template and the enterprise data, wherein the report electronic document is the reporting form electronic document completed using at least a portion of the enterprise data in compliance with the regulatory reporting requirements.

Certain embodiments disclosed herein also include a system for creating regulatory reports based on enterprise data. The system comprises: a processing circuitry; and a memory, the memory containing instructions that, when executed by the processing circuitry, configure the system to: determine if regulatory reporting requirements are satisfied based on enterprise data, wherein the enterprise data is collected from an enterprise server; retrieve a reporting form electronic document when the reporting requirements have not been satisfied, wherein the reporting form electronic document includes at least partially unstructured data; analyze the reporting form electronic document to determine at least one reporting requirement parameter relevant to the regulatory reporting requirements; create a template based on the analysis of the reporting form electronic document, wherein the template is a structured dataset including the determined at least one reporting requirement parameter; and create a report electronic document based on the template and the enterprise data, wherein the report electronic document is the reporting form electronic document completed using at least a portion of the enterprise data in compliance with the regulatory reporting requirements.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe the various disclosed embodiments.

FIG. 2 is a schematic diagram of a regulatory reporting system according to an embodiment.

FIG. 3 is a flowchart illustrating a method for automatically submitting regulatory reports based on electronic documents according to an embodiment.

FIG. 4 is a flowchart illustrating a method for creating a dataset based on at least one electronic document according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for the submission of regulatory reports based on enterprise data. Enterprise data, including financial statements, previously filed regulatory reports, and jurisdictions in which an enterprise is responsible to file such reports, is received. Regulatory reporting requirements for the relevant jurisdictions are retrieved from a web source, and it is determined whether the regulatory reporting requirements have been satisfied. If not, a reporting form electronic document is retrieved from the web source, where the reporting form electronic document is an incomplete form for a regulatory report to be filed in compliance with the requirements. The reporting form electronic document includes at least partially unstructured data. A structured dataset template is created based on the reporting form electronic document. A report electronic document is generated based on the template and the enterprise data. The report electronic document is sent, for example, to a server of a regulatory body in order to comply with the regulatory reporting requirements.

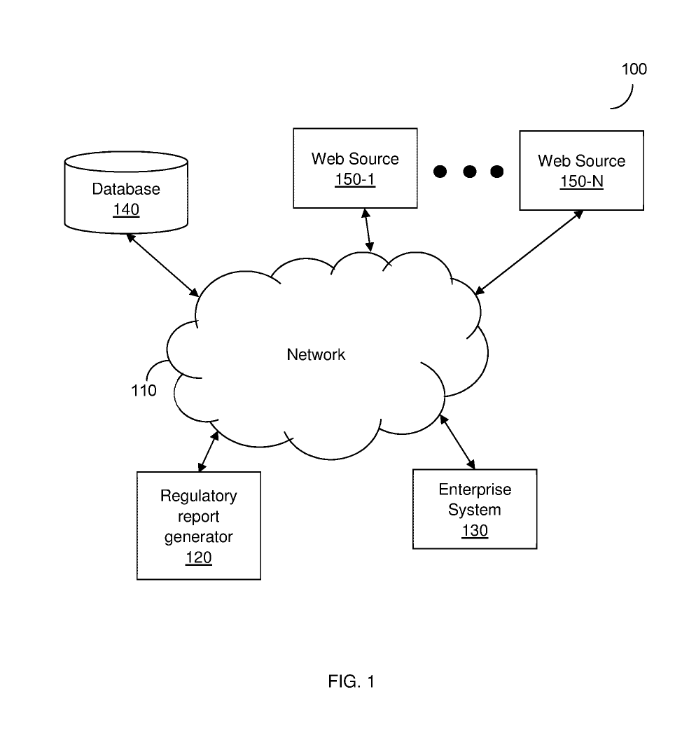

FIG. 1 shows an example network diagram 100 utilized to describe the various disclosed embodiments. In the example network diagram 100, a regulatory report generator 120, an enterprise system 130, a database 140, and a plurality of web sources 150-1 through 150-N, where N is an integer equal to or greater than 1 (hereinafter referred to individually as a web source 150 and collectively as web sources 150, merely for simplicity purposes), are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The enterprise system 130 is associated with an enterprise, and may store data related to purchases, income, or other financial data related to the enterprise or representatives of the enterprise as well as data related to the enterprise itself. The enterprise system 130 may further store data related to previously filed regulatory reports. The enterprise may be, but is not limited to, a business with presence in various jurisdictions requiring regulatory reports to be filed at specified time periods. The enterprise system 130 may be, but is not limited to, a server, a database, an enterprise resource planning system, a customer relationship management system, or any other system storing relevant data.

The data stored by the enterprise system 130 includes enterprise data such as, but not limited to, financial statements, previously filed regulatory reports, jurisdictions in which an enterprise is responsible to file regulatory reports, confirmation communications (e.g., emails) indicating submission of regulatory reports, and the like.

The database 140 may store report electronic documents generated by the regulatory report generator 120. Each report electronic document is a completed reporting form electronic document including information required for regulatory reporting as indicated in the reporting form electronic document.

The web sources 150 store at least reporting form electronic documents that may be utilized as forms for satisfying regulatory reporting requirements. The web sources 150 may include, but are not limited to, servers or devices of tax authority servers, accounting servers, regulatory bodies, and the like. As a non-limiting example, the web source 150 may be a government server storing forms to be filled and submitted for compliance with tax reporting requirements.

In an embodiment, the regulatory report generator 120 is configured to retrieve regulatory reporting requirements from one or more of the web sources 150 based on enterprise data received from the enterprise system 130. In an example implementation, the enterprise data includes at least jurisdictions in which an enterprise is required to complete regulatory reports. The regulatory reporting requirements may include rules indicating, for example, an indication of required forms, a time for submitting required forms, both, and the like.

In an embodiment, based on the regulatory reporting requirements and the enterprise data, it is determined whether the regulatory reporting requirements have been met. For example, when the regulatory reporting requirements include an indication of a required type of form, it may be checked whether the enterprise data includes an electronic confirmation indicating the required type of form has been completed and submitted in compliance with regulatory reporting requirements and, if not, it is determined that the regulatory reporting requirements have not been met.

In an embodiment, when the regulatory reporting requirements have not been met, the regulatory report generator 120 is configured to retrieve a reporting form electronic document, e.g., from one of the web sources 150, for compliance with the regulatory reporting requirements with respect to each jurisdiction for which regulatory reporting requirements have not been met.

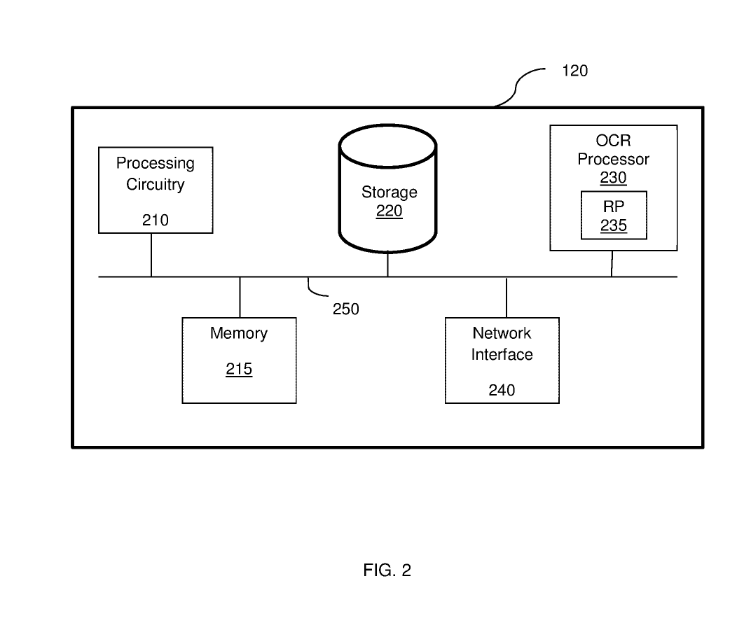

In an embodiment, the regulatory report generator 120 is configured to create datasets based on the reporting form electronic documents including data at least partially lacking a known structure (e.g., unstructured data, semi-structured data, or structured data having an unknown structure). To this end, the regulatory report generator 120 may be further configured to utilize optical character recognition (OCR) or other image processing to determine data in the reporting form electronic document. The regulatory report generator 120 may therefore include or be communicatively connected to a recognition processor (e.g., the recognition processor 235, FIG. 2).

In an embodiment, the regulatory report generator 120 is configured to analyze the created datasets to identify reporting requirement parameters related to reporting requirements indicated in the reporting form electronic documents. In an embodiment, the regulatory report generator 120 is configured to create templates based on the created datasets. Each template is a structured dataset including the identified reporting requirement parameters.

As a non-limiting example, based on the enterprise data, regulatory reporting requirements indicating that a regulatory report must be filed for an enterprise in Germany in May and in the United States in July may be retrieved from a regulatory authority server. If at least one of the required regulatory reports has not been filed, the regulatory report generator is configured to retrieve a reporting form electronic document to be completed for the relevant regulatory authority i.e., Germany, United States, or both. A template is created for each reporting form electronic document, where each template is a structured dataset including reporting requirements indicated in the reporting form electronic document. A report electronic document is completed based on each template. The respective report electronic documents may then be submitted to the relevant regulatory bodies of Germany, the United States, or both.

Using structured templates for creating a report electronic document allows for more efficient and accurate form creation than, for example, by utilizing unstructured data. Specifically, corresponding enterprise data may be utilized only with respect to relevant portions of a reporting form electronic document (e.g., portions included in specific fields of a structured template), thereby improving accuracy of form completion using appropriate enterprise data. Further, data extracted from electronic documents and organized into templates requires less memory than, for example, images of scanned documents.

In an embodiment, the enterprise system 130 may be queried for enterprise data, and at least a portion of the enterprise data may be utilized to complete portions of the reporting form electronic document associated with the reporting requirements indicated in the created template. For example, enterprise data including an annual income may be utilized to fill in a blank portion of the reporting form electronic document corresponding to a “name” reporting requirement indicated in the template.

In some implementations, the enterprise data may further include at least partially unstructured electronic documents such as, but not limited to, scans of previously completed reporting forms. To this end, in an embodiment, the regulatory report generator 120 may be configured to create templates based on the enterprise data electronic documents as described herein, where the values indicated in key fields of the enterprise data electronic document templates may be utilized to complete corresponding portions of the reporting form electronic document.

It should be noted that the embodiments described herein above with respect to FIG. 1 are described with respect to one enterprise system 130 merely for simplicity purposes and without limitation on the disclosed embodiments. Multiple enterprise systems may be equally utilized without departing from the scope of the disclosure.

FIG. 2 is an example schematic diagram of the regulatory report generator 120 according to an embodiment. The regulatory report generator 120 includes a processing circuitry 210 coupled to a memory 215, a storage 220, and a network interface 240. In an embodiment, the regulatory report generator 120 may include an optical character recognition (OCR) processor 230. In another embodiment, the components of the regulatory report generator 120 may be communicatively connected via a bus 250.

The processing circuitry 210 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The memory 215 may be volatile (e.g., RAM, etc.), non-volatile (e.g., ROM, flash memory, etc.), or a combination thereof. In one configuration, computer readable instructions to implement one or more embodiments disclosed herein may be stored in the storage 220.

In another embodiment, the memory 215 is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry 210 to perform the various processes described herein.

The storage 220 may be magnetic storage, optical storage, and the like, and may be realized, for example, as flash memory or other memory technology, CD-ROM, Digital Versatile Disks (DVDs), or any other medium which can be used to store the desired information.

The OCR processor 230 may include, but is not limited to, a feature and/or pattern recognition processor (RP) 235 configured to identify patterns, features, or both, in unstructured data sets. Specifically, in an embodiment, the OCR processor 230 is configured to identify at least characters in the unstructured data. The identified characters may be utilized to create a dataset including data required for verification of a request.

The network interface 240 allows the regulatory report generator 120 to communicate with the enterprise system 130, the database 140, the web sources 150, or a combination of, for the purpose of, for example, collecting data, retrieving data, storing data, and the like.

It should be understood that the embodiments described herein are not limited to the specific architecture illustrated in FIG. 2, and other architectures may be equally used without departing from the scope of the disclosed embodiments.

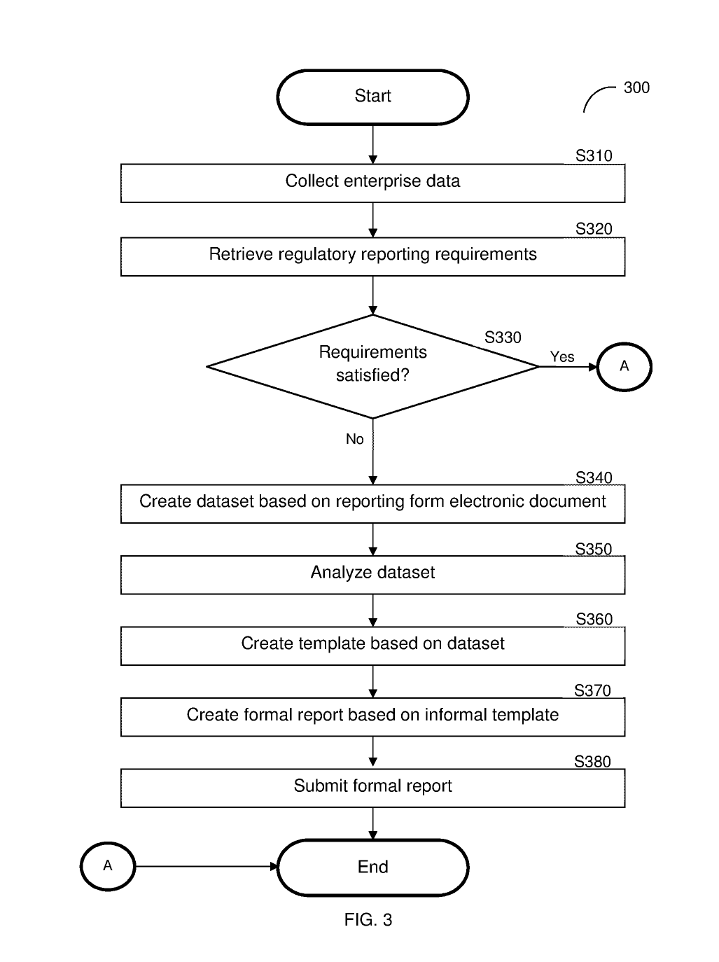

FIG. 3 is an example flowchart 300 illustrating a method for automatically assessing and submitting regulatory required documents according to an embodiment. In an embodiment, the method may be performed by a regulatory report generator (e.g., the regulatory report generator 120 of FIG. 1).

At S310, enterprise data is collected. The enterprise data includes at least jurisdictions in which an enterprise is required to report. Enterprise data may further include country of origin of the enterprise revenue data, profit data, employee data, reporting history, reporting targets, and similar data related to regulatory and tax requirements. The enterprise data may further include past fillings of regulatory documents, time periods represented by the regulatory documents, and dates and times that the documents had been submitted. The enterprise data may be collected from an enterprise system, e.g., a database storing the enterprise data.

At S320, regulatory reporting requirements are retrieved. Regulatory reporting requirements may be retrieved from web sources, such as governmental websites or databases accessible over a network, that are based on the collected enterprise data, such as which jurisdiction or jurisdictions an enterprise is required to report to. The regulatory reporting requirements may include time periods associated with the regulatory reporting, deadlines associated with the regulatory reporting, evidence of submission of completed regulatory forms, and the like. The regulatory reporting requirements may further include information from multiple regulatory bodies, such as various states and countries and regulatory and tax requirements associated therewith. In an embodiment, S320 also includes retrieving corresponding reporting form electronic documents for each set of regulatory reporting requirements from the respective web sources.

At S330, based on the collected enterprise data and the retrieved regulatory reporting requirements, it is determined if the regulatory reporting requirements have been satisfied by the enterprise, e.g., if required regulatory reports have been submitted in a timely manner to the regulatory body. In an embodiment, the enterprise data may include an electronic confirmation that is received by the enterprise when a regulatory reporting requirement has been satisfied, e.g., a confirmation email sent to an account associated with the enterprise. The email account may be accessed and searched for such an electronic confirmation. If an electronic confirmation exists within the enterprise data, the regulatory requirements are determined to have been met, and execution terminates; otherwise, execution continues with S340.

At S340, a dataset is created based on a reporting form electronic document. The reporting form electronic document may be accessed from a web source or database, and includes a reporting form for a regulatory report to be filed in compliance with regulatory reporting requirements. The reporting form electronic document includes at least partially unstructured data. In an embodiment, S340 may further include analyzing the reporting form electronic document using optical character recognition (OCR) to determine key fields and values to be completed with relevant data from the enterprise data.

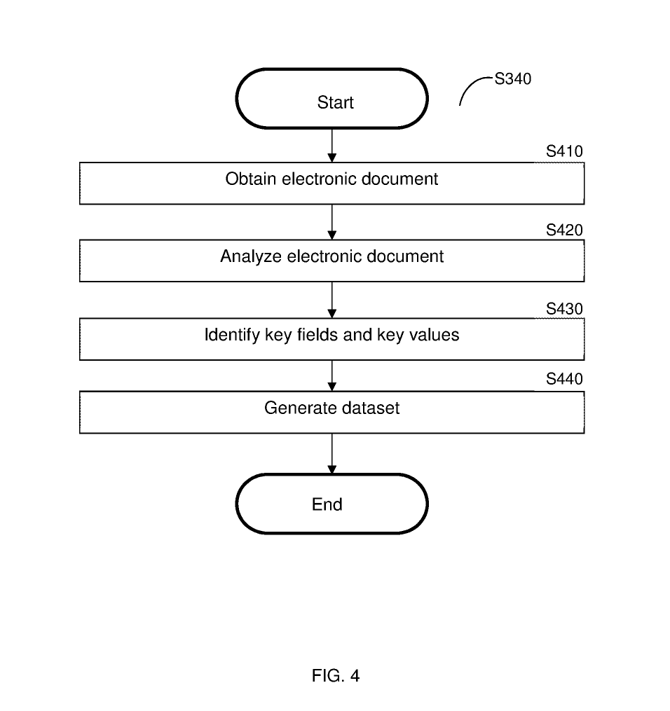

The dataset includes data associated with key fields and key values of the of the reporting form electronic document. The reporting form electronic document includes, but is not limited to, unstructured data, semi-structured data, structured data with structure that is unanticipated or unannounced, or a combination thereof. For example, the dataset may include key values indicating reporting requirements to be supplied when submitting a reporting form electronic document. Creating datasets based on electronic documents is described further herein below with respect to FIG. 4.

At S350, the created dataset is analyzed. In an embodiment, analyzing the dataset may include, but is not limited to, identifying reporting requirement parameters related to reporting requirements indicated in the reporting form electronic documents. The reporting requirement parameters may include key values that are required to be completed for compliance with the regulatory reporting requirements.

At S360, a template is created based on the dataset. The template may be, but is not limited to, a structured dataset including a plurality of fields associated with key values. The fields may include the identified reporting requirement parameters, and may be predefined.

Creating templates from electronic documents allows for faster processing due to the structured nature of the created templates. For example, query and manipulation operations may be performed more efficiently on structured datasets than on datasets lacking such structure. Further, organizing information from electronic documents into structured datasets, the amount of storage required for saving information contained in electronic documents may be significantly reduced. Electronic documents are often images that require more storage space than datasets containing the same information. For example, datasets representing data from 100,000 image electronic documents can be saved as data records in a text file. A size of such a text file would be significantly less than the size of the 100,000 images.

At S370, a report electronic document is created based on the template. A report electronic document includes a completed form that is acceptable to be submitted to a regulatory body in compliance with the regulatory reporting requirements. In an embodiment, the report electronic document is created by accessing a reporting form electronic document from a web source that is relevant to the enterprise. For example, if certain financial data must be submitted within a predefined reporting form electronic document from a regulatory authority, the report electronic document will include a completed version of the reporting form electronic document with all relevant fields filled in based on the created template.

At optional S380, the report electronic document is submitted. The submission may include uploading, emailing, or otherwise sending a completed form to a regulatory body in compliance with the regulatory reporting requirements.

FIG. 4 is an example flowchart S340 illustrating a method for creating a dataset based on an electronic document according to an embodiment.

At S410, the electronic document is obtained. Obtaining the electronic document may include, but is not limited to, receiving the electronic document (e.g., receiving a scanned image) or retrieving the electronic document (e.g., retrieving the electronic document from a consumer enterprise system, a merchant enterprise system, or a database). In an embodiment, the electronic document may be a reporting form electronic document for compliance with regulatory reporting requirements.

At S420, the electronic document is analyzed. The analysis may include, but is not limited to, using optical character recognition (OCR) to determine characters in the electronic document.

At S430, based on the analysis, key fields and values in the electronic document are identified. The key fields may include, but are not limited to, an enterprise name and address, date, income information, an enterprise's taxable status, and so on.

An electronic document may include unnecessary details that would not be considered to be key values. As an example, a logo of the merchant may not be required and, thus, is not a key value. In an embodiment, a list of key fields may be predefined, and pieces of data that may match the key fields are extracted. Then, a cleaning process is performed to ensure that the information is accurately presented. For example, if the OCR would result in a data presented as “1211212005”, the cleaning process will convert this data to Dec. 12, 2005. As another example, if a key field is presented as “Addre$s”, this will change to “Address.” The cleaning process may be performed using external information resources, such as dictionaries, calendars, and the like. In an embodiment, S430 results in a complete set of the predefined key fields and values.

At S440, a structured dataset is generated. The generated dataset includes the identified key fields and values.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for creating regulatory reports based on enterprise data, comprising:
determining if regulatory reporting requirements are satisfied based on enterprise data, wherein the enterprise data is collected from an enterprise server;
retrieving a reporting form electronic document when the reporting requirements have not been satisfied, wherein the reporting form electronic document includes at least partially unstructured data;
analyzing the reporting form electronic document to determine at least one reporting requirement parameter relevant to the regulatory reporting requirements;
creating a template based on the analysis of the reporting form electronic document, wherein the template is a structured dataset including the determined at least one reporting requirement parameter; and
creating a report electronic document based on the template and the enterprise data, wherein the report electronic document is the reporting form electronic document completed using at least a portion of the enterprise data in compliance with the regulatory reporting requirements.

2. The method of claim 1, wherein determining the at least one reporting requirement parameter further comprises:
identifying, in the reporting form electronic document, at least one key field and at least one value;
creating, based on the reporting form electronic document, a dataset, wherein the created dataset includes the at least one key field and the at least one value; and
analyzing the created dataset, wherein the at least one reporting requirement parameter is determined based on the analysis.

3. The method of claim 1, wherein creating the template includes determining at least one key field of the reporting form electronic document to be completed from the enterprise data.

4. The method of claim 3, wherein determining the at least one key field further comprises:
performing optical character recognition on the reporting form electronic document.

5. The method of claim 1, wherein the regulatory reporting requirements are retrieved from at least one web source based on the enterprise data.

6. The method of claim 1, wherein the enterprise data includes at least one of: financial statements, previously filed regulatory reports, an indication of jurisdictions in which an enterprise is responsible to file regulatory reports, confirmations of communications indicating submission of regulatory reports, time periods represented by regulatory documents, and dates and times that regulatory documents have been previously submitted.

7. The method of claim 1, wherein the regulatory reporting requirements include at least one of: regulatory forms, information to be submitted to a regulatory body, time periods associated with the regulatory reporting requirements, and deadlines associated with the regulatory reporting requirements.

8. The method of claim 1, further comprising:
sending the created report electronic document to a system of a regulatory body.

9. The method of claim 1, wherein determining if the regulatory reporting requirements have been satisfied further includes determining whether an electronic confirmation is included in the enterprise data.

10. A non-transitory computer readable medium having stored thereon instructions for causing a processing circuitry to perform a process, the process comprising:
determining if regulatory reporting requirements are satisfied based on enterprise data, wherein the enterprise data is collected from an enterprise server;
retrieving a reporting form electronic document when the reporting requirements have not been satisfied, wherein the reporting form electronic document includes at least partially unstructured data;
analyzing the reporting form electronic document to determine at least one reporting requirement parameter relevant to the regulatory reporting requirements;
creating a template based on the analysis of the reporting form electronic document, wherein the template is a structured dataset including the determined at least one reporting requirement parameter; and
creating a report electronic document based on the template and the enterprise data, wherein the report electronic document is the reporting form electronic document completed using at least a portion of the enterprise data in compliance with the regulatory reporting requirements.

11. A system for creating regulatory reports based on enterprise data, comprising:
a processing circuitry; and
a memory, the memory containing instructions that, when executed by the processing circuitry, configure the system to:
determine if regulatory reporting requirements are satisfied based on enterprise data, wherein the enterprise data is collected from an enterprise server;
retrieve a reporting form electronic document when the reporting requirements have not been satisfied, wherein the reporting form electronic document includes at least partially unstructured data;
analyze the reporting form electronic document to determine at least one reporting requirement parameter relevant to the regulatory reporting requirements;
create a template based on the analysis of the reporting form electronic document, wherein the template is a structured dataset including the determined at least one reporting requirement parameter; and
create a report electronic document based on the template and the enterprise data, wherein the report electronic document is the reporting form electronic document completed using at least a portion of the enterprise data in compliance with the regulatory reporting requirements.

12. The system of claim 11, wherein determining the at least one reporting requirement parameter further comprises:
identify, in the reporting form electronic document, at least one key field and at least one value;
create, based on the reporting form electronic document, a dataset, wherein the created dataset includes the at least one key field and the at least one value; and
analyze the created dataset, wherein the at least one reporting requirement parameter is determined based on the analysis.

13. The system of claim 11, wherein creating the template includes determining at least one key field of the reporting form electronic document to be completed from the enterprise data.

14. The system of claim 13, wherein determining the at least one key field further comprises:
perform optical character recognition on the reporting form electronic document.

15. The system of claim 11, wherein the regulatory reporting requirements are retrieved from at least one web source based on the enterprise data.

16. The system of claim 11, wherein the enterprise data includes at least one of: financial statements, previously filed regulatory reports, an indication of jurisdictions in which an enterprise is responsible to file regulatory reports, confirmations of communications indicating submission of regulatory reports, time periods represented by regulatory documents, and dates and times that regulatory documents have been previously submitted.

17. The system of claim 11, wherein the regulatory reporting requirements include at least one of: regulatory forms, information to be submitted to a regulatory body, time periods associated with the regulatory reporting requirements, and deadlines associated with the regulatory reporting requirements.

18. The system of claim 11, wherein the system is further configured to:
send the created report electronic document to a system of a regulatory body.

19. The system of claim 11, wherein determining if the regulatory reporting requirements have been satisfied further includes determining whether an electronic confirmation is included in the enterprise data.
